(19) United States
(12) Patent Application Publication
(10) Pub. No.: US 2022/0173889 A1
(43) Pub. Date: Jun. 2, 2022

(54) Secure Safety-Critical System Log

(71) Applicant: Motional AD LLC, Boston, MA (US)

(72) Inventors: Charles James Wilson, Hudson, NH (US); Michael Maass, Pittsburgh, PA (US); James Margaria, Allison Park, PA (US)

(21) Appl. No.: 17/107,912

(22) Filed: Nov. 30, 2020

(51) Int. Cl. H04L 9/06; H04L 9/32; G06F 11/10; G06F 16/23

(52) U.S. Cl. CPC H04L 9/0643; H04L 9/3297; H04L 2209/84; G06F 16/2379; H04L 2209/38; G06F 11/1004

(57) ABSTRACT

Embodiments are disclosed for secure safety-critical system log. In an embodiment, a method comprises: obtaining data to be added to a log; creating an entry for the data; and adding the entry to a sequence of chained entries in the log, wherein: the sequence of chained entries includes a number of data entries and a number of sentinels interleaved with the number of data entries, wherein each data entry in the chain of entries is appended to an error-detecting code computed for the entry and a previously computed error-detecting code of a preceding data entry or an error-detecting root, and each sentinel in the chain of entries includes an error-detecting code computed for the sentinel and a previously computed error-detecting code of a preceding data entry or the error-detecting root, and each sentinel includes a previously computed and encrypted blockchain value of a preceding sentinel or a blockchain root value.

### FIELD OF THE INVENTION

The description that follows relates generally to securing safety-critical system logs, and in particular to securing safety-critical system logs that are constrained by computational power and logging frequency.

### BACKGROUND

An event log is a computer data structure that records events that occur during the operation of a system to provide a data trail that can be used to understand the activity of the system and to diagnose problems. Because logs for safety-critical systems are important for reconstructing safety incidents, it is desirable to ensure that log entries have not been tampered with. For example, it is important that verifiably accurate log entries be maintained for autonomous vehicles so that the log entries can be used to determine the cause of a safety incident involving an autonomous vehicle and a pedestrian or another vehicle.

### SUMMARY

Techniques are provided for a secure safety-critical system log.

In an embodiment, a method comprises: obtaining data to be added to a log; creating an entry for the data; and adding the entry to a sequence of chained entries in the log, wherein: the sequence of chained entries includes a number of data entries and a number of sentinels interleaved with the number of data entries, wherein each data entry in the chain of entries is appended to an error-detecting code computed for the entry and a previously computed error-detecting code of a preceding data entry or an error-detecting root, and each sentinel in the chain of entries includes an error-detecting code computed for the sentinel and a previously computed error-detecting code of a preceding data entry or the error-detecting root, and each sentinel includes a previously computed and encrypted blockchain value of a preceding sentinel or a blockchain root value.

In an embodiment, the error-detecting code is cyclic-redundancy check (CRC) code.

In an embodiment, a first entry in the chain of entries includes the blockchain root value and a second entry, following the first entry, in the chain of entries includes the error-detecting root.

In an embodiment, a first log entry in the chain of entries includes the error-detecting root and a second entry, following the first entry, in the chain of entries includes the blockchain root value.

In an embodiment, each sentinel further includes identification data indicating that the sentinel is a sentinel.

In an embodiment, the sentinels are interleaved with the data entries at a specified frequency determined by a timing constraint.

In an embodiment, the sentinels are interleaved with the data entries at a specified frequency determined by a window of interest within the log.

In an embodiment, each encrypted blockchain value is a hash generated by a cryptographic operation.

In an embodiment, each data entry and each sentinel includes a timestamp.

In an embodiment, the data entry includes data associated with an autonomous vehicle.

In an embodiment, a log management system comprises: at least one processor; and memory storing instructions that when executed by the at least one processor, causes the at least one processor to add an entry to a log comprising a chained sequence of entries, where each chained entry in the chained sequence of entries is either a data entry or a sentinel, where each sentinel includes an encrypted blockchain value based on a previously computed blockchain value stored in a preceding sentinel and a previously computed error-detecting code stored in a preceding data entry, and wherein the error-detecting code tracks through the sentinels and the data entries in the chain of entries.

In an embodiment, at creation of the log, a blockchain root value and error-detecting root value are written to the log and an initial sentinel entry is created and written to the log, subsequent entries in the log use an in-memory value of the CRC in creation of a CRC for new log entries for sentinel and data entries, and whenever sentinel entries are written, an in-memory blockchain value is used.

One or more of the disclosed embodiments provide one or more of the following advantages. The speed advantage of chained entry methodology is combined with the cryptographic advantage of blockchain technology to provide a secure safety-critical system log that is verifiably accurate, and that can be created and maintained by systems that are constrained by computational power and logging frequency.

These and other aspects, features, and implementations can be expressed as methods, apparatus, systems, components, program products, means or steps for performing a function, and in other ways.

These and other aspects, features, and implementations will become apparent from the following descriptions, including the claims.

### BRIEF DESCRIPTION OF THE DRAWINGS

FIG. 1 shows an example of an autonomous vehicle (AV) having autonomous capability, in accordance with one or more embodiments.

FIG. 2 illustrates an example “cloud” computing environment, in accordance with one or more embodiments.

FIG. 3 illustrates a computer system, in accordance with one or more embodiments.

FIG. 4 shows an example architecture for an AV, in accordance with one or more embodiments.

FIG. 5 is a block diagram of a log management system for creating and maintaining secure safety-critical system logs, in accordance with one or more embodiments.

FIG. 6A illustrates an example entry sequence in accordance with one or more embodiments.

FIG. 6B illustrates a cyclic redundancy check (CRC) augmented log methodology, in accordance with one or more embodiments.

FIG. 6C illustrates a CRC augmented entries methodology, in accordance with one or more embodiments.

FIG. 6D illustrates a CRC augmented log of CRC augmented entries methodology, in accordance with one or more embodiments.

FIG. 6E illustrates a CRC chained entry methodology, in accordance with one or more embodiments.

FIG. 6F illustrates a blockchain of entries methodology in accordance with one or more embodiments.

FIG. 7 illustrates a combined CRC chained entries methodology and blockchain of entries methodology, in accordance with one or more embodiments.

FIG. 8 is a flow diagram of a process of generating a secure safety-critical system log that combines CRC chained entry methodology with blockchain entry methodology, in accordance with one or more embodiments.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

In the drawings, specific arrangements or orderings of schematic elements, such as those representing devices, modules, instruction blocks and data elements, are shown for ease of description. However, it should be understood by those skilled in the art that the specific ordering or arrangement of the schematic elements in the drawings is not meant to imply that a particular order or sequence of processing, or separation of processes, is required. Further, the inclusion of a schematic element in a drawing is not meant to imply that such element is required in all embodiments or that the features represented by such element may not be included in or combined with other elements in some embodiments.

Further, in the drawings, where connecting elements, such as solid or dashed lines or arrows, are used to illustrate a connection, relationship, or association between or among two or more other schematic elements, the absence of any such connecting elements is not meant to imply that no connection, relationship, or association can exist. In other words, some connections, relationships, or associations between elements are not shown in the drawings so as not to obscure the disclosure. In addition, for ease of illustration, a single connecting element is used to represent multiple connections, relationships or associations between elements. For example, where a connecting element represents a communication of signals, data, or instructions, it should be understood by those skilled in the art that such element represents one or multiple signal paths (e.g., a bus), as may be needed, to affect the communication.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

Several features are described hereafter that can each be used independently of one another or with any combination of other features. However, any individual feature may not address any of the problems discussed above or might only address one of the problems discussed above. Some of the problems discussed above might not be fully addressed by any of the features described herein. Although headings are provided, information related to a particular heading, but not found in the section having that heading, may also be found elsewhere in this description. Embodiments are described herein according to the following outline:
1. General Overview
2. Autonomous Vehicle System Overview
3. Example Cloud Computing Architecture
4. Example Computer System
5. Example Autonomous Vehicle Architecture
6. Example Log Management System
7. Overview of Secure System Log Methodologies
8. Secure Safety-Critical System Log

General Overview

The disclosed embodiments combine the speed advantage of chained entries methodology with the security advantage of blockchain technology to ensure verifiably accurate log data for safety-critical systems with constrained computational power or logging frequency.

Autonomous Vehicle System Overview

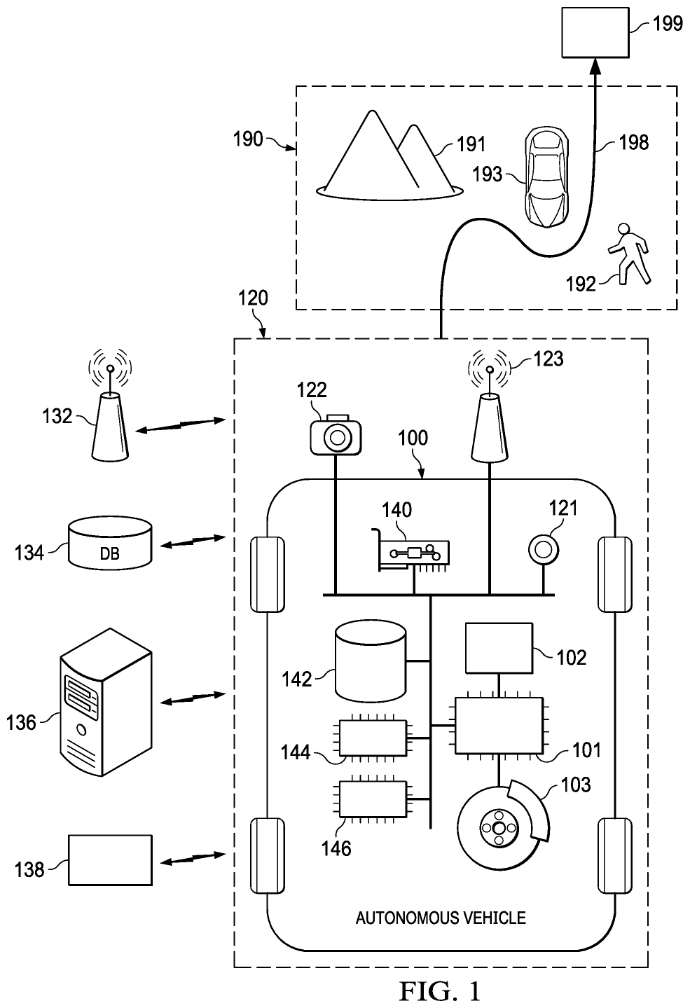

FIG. 1 shows an example of an autonomous vehicle 100 having autonomous capability.

As used herein, the term “autonomous capability” refers to a function, feature, or facility that enables a vehicle to be partially or fully operated without real-time human intervention, including without limitation fully autonomous vehicles, highly autonomous vehicles, and conditionally autonomous vehicles.

As used herein, an autonomous vehicle (AV) is a vehicle that possesses autonomous capability.

As used herein, “vehicle” includes means of transportation of goods or people. For example, cars, buses, trains, airplanes, drones, trucks, boats, ships, submersibles, dirigibles, etc. A driverless car is an example of a vehicle.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “includes,” and/or “including,” when used in this description, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

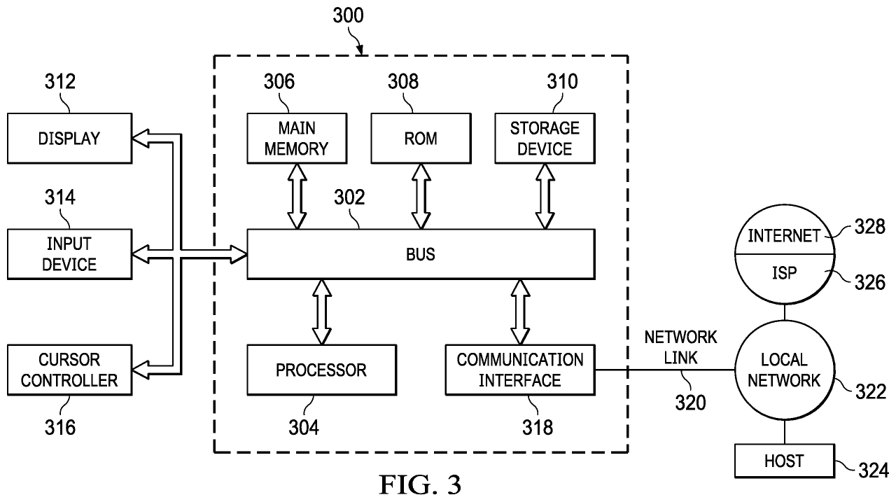

As used herein, an AV system refers to the AV along with the array of hardware, software, stored data, and data generated in real-time that supports the operation of the AV. In an embodiment, the AV system is incorporated within the AV. In an embodiment, the AV system is spread across several locations. For example, some of the software of the AV system is implemented on a cloud computing environment similar to cloud computing environment 300 described below with respect to FIG. 3.

Referring to FIG. 1, an AV system 120 operates the AV 100 along a trajectory 198 through an environment 190 to a destination 199 (sometimes referred to as a final location) while avoiding objects (e.g., natural obstructions 191, vehicles 193, pedestrians 192, cyclists, and other obstacles) and obeying rules of the road (e.g., rules of operation or driving preferences).

In an embodiment, the AV system 120 includes devices 101 that are instrumented to receive and act on operational commands from the computer processors 146. In an embodiment, computing processors 146 are similar to the processor 304 described below in reference to FIG. 3. Examples of devices 101 include a steering control 102, brakes 103, gears, accelerator pedal or other acceleration control mechanisms, windshield wipers, side-door locks, window controls, and turn-indicators.

In an embodiment, the AV system 120 includes sensors 121 for measuring or inferring properties of state or condition of the AV 100, such as the AV's position, linear velocity and acceleration, angular velocity and acceleration, and heading (e.g., an orientation of the leading end of AV 100). Example of sensors 121 are GNSS, inertial measurement units (IMU) that measure both vehicle linear accelerations and angular rates, wheel speed sensors for measuring or estimating wheel slip ratios, wheel brake pressure or braking torque sensors, engine torque or wheel torque sensors, and steering angle and angular rate sensors.

In an embodiment, the sensors 121 also include sensors for sensing or measuring properties of the AV's environment. For example, monocular or stereo video cameras 122 in the visible light, infrared or thermal (or both) spectra, LiDAR 123, RADAR, ultrasonic sensors, time-of-flight (TOF) depth sensors, speed sensors, temperature sensors, humidity sensors, and precipitation sensors.

In an embodiment, the AV system 120 includes a data storage unit 142 and memory 144 for storing machine instructions associated with computer processors 146 or data collected by sensors 121. In an embodiment, the data storage unit 142 is similar to the ROM 308 or storage device 310 described below in relation to FIG. 3. In an embodiment, memory 144 is similar to the main memory 306 described below. In an embodiment, the data storage unit 142 and memory 144 store historical, real-time, and/or predictive information about the environment 190. In an embodiment, the stored information includes maps, driving performance, traffic congestion updates or weather conditions. In an embodiment, data relating to the environment 190 is transmitted to the AV 100 via a communications channel from a remotely located database 134.

In an embodiment, the AV system 120 includes communications devices 140 for communicating measured or inferred properties of other vehicles' states and conditions, such as positions, linear and angular velocities, linear and angular accelerations, and linear and angular headings to the AV 100. These devices include Vehicle-to-Vehicle (V2V) and Vehicle-to-Infrastructure (V2I) communication devices and devices for wireless communications over point-to-point or ad hoc networks or both. In an embodiment, the communications devices 140 communicate across the electromagnetic spectrum (including radio and optical communications) or other media (e.g., air and acoustic media). A combination of Vehicle-to-Vehicle (V2V) Vehicle-to-Infrastructure (V2I) communication (and, in some embodiments, one or more other types of communication) is sometimes referred to as Vehicle-to-Everything (V2X) communication. V2X communication typically conforms to one or more communications standards for communication with, between, and among autonomous vehicles.

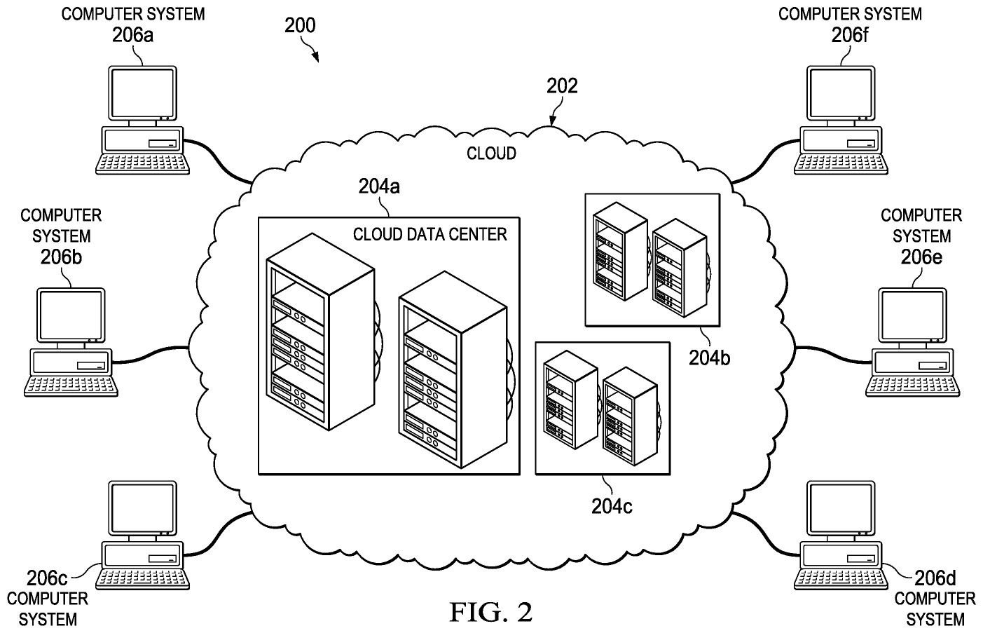

In an embodiment, the communication devices 140 include communication interfaces. For example, wired, wireless, WiMAX, Wi-Fi, Bluetooth, satellite, cellular, optical, near field, infrared, or radio interfaces. The communication interfaces transmit data from a remotely located database 134 to AV system 120. In an embodiment, the remotely located database 134 is embedded in a cloud computing environment 200 as described in FIG. 2. The communication interfaces 140 transmit data collected from sensors 121 or other data related to the operation of AV 100 to the remotely located database 134. In an embodiment, communication interfaces 140 transmit information that relates to teleoperations to the AV 100. In some embodiments, the AV 100 communicates with other remote (e.g., “cloud”) servers 136.

In an embodiment, the remotely located database 134 also stores and transmits digital data (e.g., storing data such as road and street locations). Such data is stored on the memory 144 on the AV 100, or transmitted to the AV 100 via a communications channel from the remotely located database 134.

In an embodiment, the remotely located database 134 stores and transmits historical information about driving properties (e.g., speed and acceleration profiles) of vehicles that have previously traveled along trajectory 198 at similar times of day. In one implementation, such data may be stored on the memory 144 on the AV 100, or transmitted to the AV 100 via a communications channel from the remotely located database 134.

Computing devices 146 located on the AV 100 algorithmically generate control actions based on both real-time sensor data and prior information, allowing the AV system 120 to execute its autonomous driving capabilities.

In an embodiment, the AV system 120 includes computer peripherals 132 coupled to computing devices 146 for providing information and alerts to, and receiving input from, a user (e.g., an occupant or a remote user) of the AV 100. In an embodiment, peripherals 132 are similar to the display 312, input device 314, and cursor controller 316 discussed below in reference to FIG. 3. The coupling is wireless or wired. Any two or more of the interface devices may be integrated into a single device.

### Example Cloud Computing Environment

FIG. 2 illustrates an example “cloud” computing environment. Cloud computing is a model of service delivery for enabling convenient, on-demand network access to a shared pool of configurable computing resources (e.g. networks, network bandwidth, servers, processing, memory, storage, applications, virtual machines, and services). In typical cloud computing systems, one or more large cloud data centers house the machines used to deliver the services provided by the cloud. Referring now to FIG. 2, the cloud computing environment 200 includes cloud data centers 204a, 204b, and 204c that are interconnected through the cloud 202. Data centers 204a, 204b, and 204c provide cloud computing services to computer systems 206a, 206b, 206c, 206d, 206e, and 206f connected to cloud 202.

The cloud computing environment 200 includes one or more cloud data centers. In general, a cloud data center, for example the cloud data center 204a shown in FIG. 2, refers to the physical arrangement of servers that make up a cloud, for example the cloud 202 shown in FIG. 2, or a particular portion of a cloud. For example, servers are physically arranged in the cloud datacenter into rooms, groups, rows, and racks. A cloud datacenter has one or more zones, which include one or more rooms of servers. Each room has one or more rows of servers, and each row includes one or more racks. Each rack includes one or more individual server nodes. In some implementation, servers in zones, rooms, racks, and/or rows are arranged into groups based on physical infrastructure requirements of the datacenter facility, which include power, energy, thermal, heat, and/or other requirements. In an embodiment, the server nodes are similar to the computer system described in FIG. 3. The data center 204a has many computing systems distributed through many racks.

The cloud 202 includes cloud data centers 204a, 204b, and 204c along with the network and networking resources (for example, networking equipment, nodes, routers, switches, and networking cables) that interconnect the cloud data centers 204a, 204b, and 204c and help facilitate the computing systems' 206a-f access to cloud computing services. In an embodiment, the network represents any combination of one or more local networks, wide area networks, or internetworks coupled using wired or wireless links deployed using terrestrial or satellite connections. Data exchanged over the network, is transferred using any number of network layer protocols, such as Internet Protocol (IP), Multiprotocol Label Switching (MPLS), Asynchronous Transfer Mode (ATM), Frame Relay, etc. Furthermore, in embodiments where the network represents a combination of multiple sub-networks, different network layer protocols are used at each of the underlying sub-networks. In some embodiments, the network represents one or more interconnected internetworks, such as the public Internet.

The computing systems 206a-f or cloud computing services consumers are connected to the cloud 202 through network links and network adapters. In an embodiment, the computing systems 206a-f are implemented as various computing devices, for example servers, desktops, laptops, tablet, smartphones, Internet of Things (IoT) devices, autonomous vehicles (including, cars, drones, shuttles, trains, buses, etc.) and consumer electronics. In an embodiment, the computing systems 206a-f are implemented in or as a part of other systems.

### Example Computer System

FIG. 3 illustrates a computer system 300. In an implementation, the computer system 300 is a special purpose computing device. The special-purpose computing device is hard-wired to perform the techniques or includes digital electronic devices such as one or more application-specific integrated circuits (ASICs) or field programmable gate arrays (FPGAs) that are persistently programmed to perform the techniques or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. In various embodiments, the special-purpose computing devices are desktop computer systems, portable computer systems, handheld devices, network devices or any other device that incorporates hard-wired and/or program logic to implement the techniques.

In an embodiment, the computer system 300 includes a bus 302 or other communication mechanism for communicating information, and a hardware processor 304 coupled with a bus 302 for processing information. The hardware processor 304 is, for example, a general-purpose microprocessor. The computer system 300 also includes a main memory 306, such as a random-access memory (RAM) or other dynamic storage device, coupled to the bus 302 for storing information and instructions to be executed by processor 304. In one implementation, the main memory 306 is used for storing temporary variables or other intermediate information during execution of instructions to be executed by the processor 304. Such instructions, when stored in non-transitory storage media accessible to the processor 304, render the computer system 300 into a special-purpose machine that is customized to perform the operations specified in the instructions.

In an embodiment, the computer system 300 further includes a read-only memory (ROM) 308 or other static storage device coupled to the bus 302 for storing static information and instructions for the processor 304. A storage device 310, such as a magnetic disk, optical disk, solid-state drive, or three-dimensional cross point memory is provided and coupled to the bus 302 for storing information and instructions.

In an embodiment, the computer system 300 is coupled via the bus 302 to a display 312, such as a cathode ray tube (CRT), a liquid crystal display (LCD), plasma display, light emitting diode (LED) display, or an organic light emitting diode (OLED) display for displaying information to a computer user. An input device 314, including alphanumeric and other keys, is coupled to bus 302 for communicating information and command selections to the processor 304. Another type of user input device is a cursor controller 316, such as a mouse, a trackball, a touch-enabled display, or cursor direction keys for communicating direction information and command selections to the processor 304 and for controlling cursor movement on the display 312. This input device typically has two degrees of freedom in two axes, a first axis (e.g., x-axis) and a second axis (e.g., y-axis), that allows the device to specify positions in a plane.

According to one embodiment, the techniques herein are performed by the computer system 300 in response to the processor 304 executing one or more sequences of one or more instructions contained in the main memory 306. Such instructions are read into the main memory 306 from another storage medium, such as the storage device 310. Execution of the sequences of instructions contained in the main memory 306 causes the processor 304 to perform the process steps described herein. In alternative embodiments, hard-wired circuitry is used in place of or in combination with software instructions.

The term “storage media” as used herein refers to any non-transitory media that store data and/or instructions that cause a machine to operate in a specific fashion. Such storage media includes non-volatile media and/or volatile media. Non-volatile media includes, for example, optical disks, magnetic disks, solid-state drives, or three-dimensional cross point memory, such as the storage device 310. Volatile media includes dynamic memory, such as the main memory 306. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NV-RAM, or any other memory chip or cartridge.

Storage media is distinct from but may be used in conjunction with transmission media. Transmission media participates in transferring information between storage media. For example, transmission media includes coaxial cables, copper wire and fiber optics, including the wires that include the bus 302. Transmission media can also take the form of acoustic or light waves, such as those generated during radio-wave and infrared data communications.

In an embodiment, various forms of media are involved in carrying one or more sequences of one or more instructions to the processor 304 for execution. For example, the instructions are initially carried on a magnetic disk or solid-state drive of a remote computer. The remote computer loads the instructions into its dynamic memory and send the instructions over a telephone line using a modem. A modem local to the computer system 300 receives the data on the telephone line and use an infrared transmitter to convert the data to an infrared signal. An infrared detector receives the data carried in the infrared signal and appropriate circuitry places the data on the bus 302. The bus 302 carries the data to the main memory 306, from which processor 304 retrieves and executes the instructions. The instructions received by the main memory 306 may optionally be stored on the storage device 310 either before or after execution by processor 304.

The computer system 300 also includes a communication interface 318 coupled to the bus 302. The communication interface 318 provides a two-way data communication coupling to a network link 320 that is connected to a local network 322. For example, the communication interface 318 is an integrated service digital network (ISDN) card, cable modem, satellite modem, or a modem to provide a data communication connection to a corresponding type of telephone line. As another example, the communication interface 318 is a local area network (LAN) card to provide a data communication connection to a compatible LAN. In some implementations, wireless links are also implemented. In any such implementation, the communication interface 318 sends and receives electrical, electromagnetic, or optical signals that carry digital data streams representing various types of information.

The network link 320 typically provides data communication through one or more networks to other data devices. For example, the network link 320 provides a connection through the local network 322 to a host computer 324 or to a cloud data center or equipment operated by an Internet Service Provider (ISP) 326. The ISP 326 in turn provides data communication services through the worldwide data communication network now commonly referred to as the “Internet” 328. The local network 322 and Internet 328 both use electrical, electromagnetic, or optical signals that carry digital data streams. The signals through the various networks and the signals on the network link 320 and through the communication interface 318, which carry the digital data to and from the computer system 300, are example forms of transmission media. In an embodiment, the network 320 contains the cloud 202 or a part of the cloud 202 described above.

The computer system 300 sends messages and receives data, including program code, through the network(s), the network link 320, and the communication interface 318. In an embodiment, the computer system 300 receives code for processing. The received code is executed by the processor 304 as it is received, and/or stored in storage device 310, or other non-volatile storage for later execution.

### Example Autonomous Vehicle Architecture

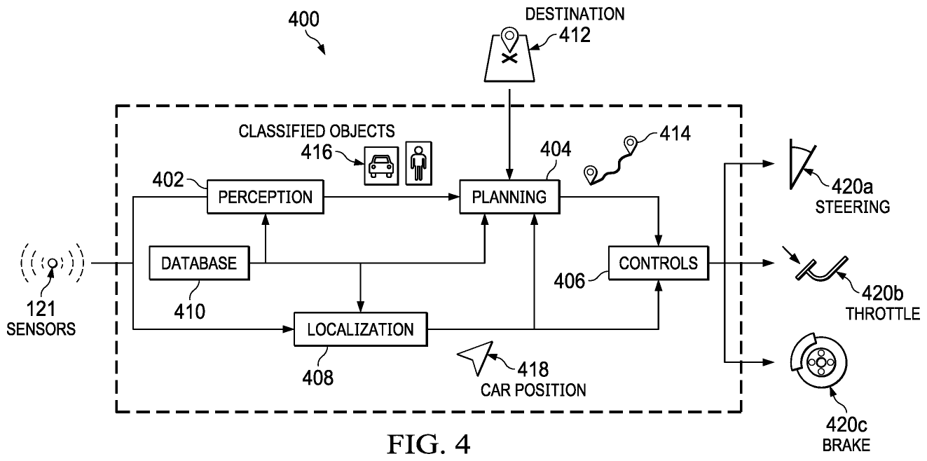

FIG. 4 shows an example architecture 400 for an autonomous vehicle (e.g., the AV 100 shown in FIG. 1). The architecture 400 includes a perception module 402 (sometimes referred to as a perception circuit), a planning module 404 (sometimes referred to as a planning circuit), a control module 406 (sometimes referred to as a control circuit), a localization module 408 (sometimes referred to as a localization circuit), and a database module 410 (sometimes referred to as a database circuit). Each module plays a role in the operation of the AV 100. Together, the modules 402, 404, 406, 408, and 410 may be part of the AV system 120 shown in FIG. 1. In some embodiments, any of the modules 402, 404, 406, 408, and 410 is a combination of computer software (e.g., executable code stored on a computer-readable medium) and computer hardware (e.g., one or more microprocessors, microcontrollers, application-specific integrated circuits [ASICs]), hardware memory devices, other types of integrated circuits, other types of computer hardware, or a combination of any or all of these things).

In use, the planning module 404 receives data representing a destination 412 and determines data representing a trajectory 414 (sometimes referred to as a route) that can be traveled by the AV 100 to reach (e.g., arrive at) the destination 412. In order for the planning module 404 to determine the data representing the trajectory 414, the planning module 404 receives data from the perception module 402, the localization module 408, and the database module 410.

The perception module 402 identifies nearby physical objects using one or more sensors 121, e.g., as also shown in FIG. 1. The objects are classified (e.g., grouped into types such as pedestrian, bicycle, automobile, traffic sign, etc.) and a scene description including the classified objects 416 is provided to the planning module 404.

The planning module 404 also receives data representing the AV position 418 from the localization module 408. The localization module 408 determines the AV position by using data from the sensors 121 and data from the database module 410 (e.g., a geographic data) to calculate a position. For example, the localization module 408 uses data from a GNSS (Global Operation Satellite System) sensor and geographic data to calculate the longitude and latitude of the AV. In an embodiment, data used by the localization module 408 includes high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations of them), and maps describing the spatial locations of road features such as crosswalks, traffic signs or other travel signals of various types.

The control module 406 receives the data representing the trajectory 414 and the data representing the AV position 418 and operates the control functions 420a-c (e.g., steering, throttling, braking, ignition) of the AV in a manner that will cause the AV 100 to travel the trajectory 414 to the destination 412. For example, if the trajectory 414 includes a left turn, the control module 406 will operate the control functions 420a-c in a manner such that the steering angle of the steering function will cause the AV 100 to turn left and the throttling and braking will cause the AV 100 to pause and wait for passing pedestrians or vehicles before the turn is made.

### Example Log Management System

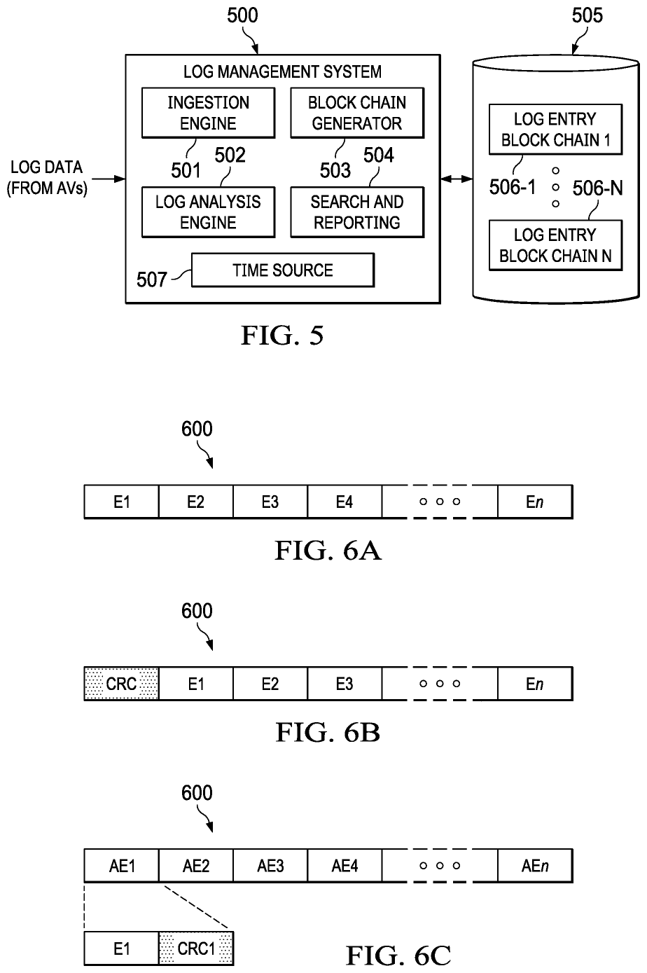

FIG. 5 is a block diagram of log management system 500 for creating and maintaining secure safety-critical system logs, in accordance with one or more embodiments. System 500 includes ingestion engine 501, log analysis engine 502, chained entry generator 503, search and reporting 504 and time source 507. System 500 generates chained entries 506-1 through 506-N. System 500 can be used in any system where secure safety-critical system logs need to be generated and the system is constrained by computational power or logging frequency. In an embodiment, system 500 can be centralized or distributed. In an embodiment, system 500 is used by AV system 120 and/or the AV 100. For example, secure safety-critical system logs can be stored in one or more of database 134 (FIG. 1), storage device 310 of computer system 300, cloud data center 204a or sensor database 410.

The types of log data that can be stored include data generated by sensors 121, perception module 402, planning module 404, control module 406, localization module 408 or any other output of the AV software stack or a hardware component of AV 100 and/or AV system 120. System log data can also include data that is received from data sources external to AV 100, such as weather and traffic conditions or data provided by other vehicles or infrastructure.

Referring to FIG. 5, ingestion engine 501 is responsible for receiving and/or collecting data to be logged from various data sources. In an embodiment, ingestion engine 501 is configured to receive or collect event log data that is sent by the various data sources in the AV 100. For example, data streams from sensors (e.g., optical, LiDAR, RADAR, SONAR) and the AV software stack, such as from modules 402, 404, 406, 408, can be received or collected by ingestion engine 501. The data streams can be obtained from, for example, a controller area network (CAN) bus, CAN flexible data rate (CAN-FD) bus and/or from a vehicle Ethernet. The entries of a log may be plaintext, binary data, or a combination of the two. Each entry is delineated in a manner which allows it to be separated from its neighbor entries in a sequence of entries. Each entry is presumed to include a timestamp, provided by time source 507. The timestamp is presumed to have sufficient resolution to be meaningful within the context of the frequency of the logging. To assist the reader in understanding the enclosed embodiments, several secure system log methodologies and their inherent advantages and disadvantages are described below.

Log analysis engine 502 can be implemented using one or more computers (e.g., computer system 300) with a graphical user interface (GUI) and/or command line that allows a data analyst to query for specific log entries using search and reporting engine 504. Log analysis engine 502 performs various types of log analysis for use by the data analyst, including analyses related to data security and integrity.

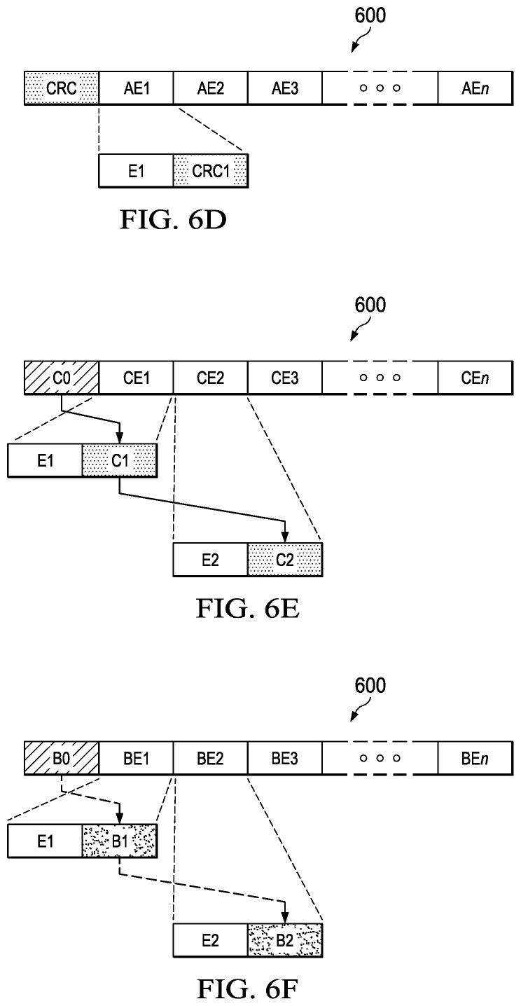

Chained entry generator 503 creates chained entries using blockchain technology, as described in further detail in reference to FIGS. 6A-6F, 7 and 8.

### Overview of Secure System Log Methodologies

FIG. 6A illustrates a log 600 in accordance with one or more embodiments. One of the purposes of log files within a system is to provide a record of events contributing to an incidence. For example, in an AV the incident could be a collision of the AV with a pedestrian or another vehicle. It is critical to establish that the log files have not been altered, thereby making it difficult to determine the actual events leading up to the incident. In some embodiments, no safeguards are put in place to prevent tampering. In the example shown, log 600 includes a contiguous sequence of “n” entries (E1 . . . En). It is assumed that the log management system 500 is constrained, such that the computational power of a cryptographic unit used to perform cryptographic operations on the log data (such as encrypting individual log entries, or decrypting and re-encrypting the entire log file when new entries are added) in a timely manner is insufficient to match required logging frequency of the system.

### Cyclic Redundancy Check (CRC) Augmented Log Methodology

FIG. 6B illustrates a cyclic-redundancy check (CRC) augmented log methodology, in accordance with one or more embodiments. The overall integrity of a log can be established by use of a CRC. A CRC is an error-detecting code commonly used in digital networks and storage devices to detect accidental changes to raw data. A CRC augmented methodology calculates a short, fixed-length binary sequence for the log 600 (hereinafter, also referred to as the “CRC”) forming a codeword. When the codeword is read by the log management system 500, the CRC of the codeword is either compared with a new CRC calculated from the entries of log 600 or performs a CRC on the whole codeword, and compares the resulting CRC with an expected residue constant. If the CRCs do not match, then the log 600 is assumed to contain a data error. Log management system 500 can then take corrective action, such as rereading the log 600. Otherwise, the log 600 is assumed to be error-free with a small probability that the log may contain undetected errors inherent to the CRC methodology.

The CRC augmented log is illustrated by FIG. 6B. Each time a new entry is added to log 600 a single CRC for the entire log (“CRC”) is updated. To reflect the possibility that logging may be interrupted due to an incident, the log CRC is located at the beginning of log 600. After a new entry is appended to the log 600, the log CRC is updated. Note that although unintentional damage can be detected by the log CRC, the intentional alteration of both the content in the entries (E1 . . . En) and the log CRC cannot be detected.

In sum, the CRC augmented log methodology has negligible additional computational cost and does not provide detection of unintentional or intentional damage to an individual log entry.

### CRC Augmented Entries Methodology

FIG. 6C illustrates a CRC augmented entries methodology, in accordance with one or more embodiments. Instead of augmenting log 600 with one CRC, each entry in log 600 is augmented with its own entry CRC. In the example shown, entry E1 is augmented with CRC1 computed from data entry E1.

While the CRC augmented entry methodology can determine damage to entry contents, it does so at the expense of increasing the log size by the number of entries multiplied by the size of the CRC codeword. Also, intentional data insertions and deletions of entries are not detected by CRC augmented entry methodology. Thus, the CRC augmented entries methodology has low additional computational cost, protects against unintentional damage to entries but does not protect against intentional damage to entries.

### CRC Augmented Log of CRC Augmented Entries Methodology

FIG. 6D illustrates a CRC augmented log of CRC augmented entries methodology, in accordance with one or more embodiments. A log CRC is located at the beginning of the log 600 and an entry CRC is appended to each entry in log 600. In the example shown, a first augmented entry (AE1) includes entry data E1 and CRC1. Each of the subsequent entries (E2 . . . En) also have respective CRC values (CRC2 . . . CRCn).

Combining the CRC augmented log methodology with the CRC augmented entry methodology allows for detection of trivial insertions or deletions in log 600. The intentional manipulation of data and/or CRCs, however, is not detected.

### Chained CRC of Entries Methodology

FIG. 6E illustrates a chained CRC of entries methodology, in accordance with one or more embodiments. With this methodology, log 600 includes CRC-chained entries (CE1 . . . CEn), where the CRC of each entry (C1 . . . Cn) is linked to its preceding entry's CRC as the first element of the current entry's CRC computation. In the example shown, an arbitrary root CRC (C0) is located at the beginning of log 600 and is linked to C1 of entry CE1. Similarly, C1 is linked to C2 of CE2 and so forth.

The cost of the chained CRC entries methodology is similar to the cost of the CRC augmented log of CRC augmented entries methodology, but with a better guarantee of tamper/damage detection due to updating of all entry CRCs following an insertion of a new entry or deletion of an existing entry in the log.

### Blockchain of Entries Methodology

FIG. 6F illustrates a blockchain of entries methodology in accordance with one or more embodiments. In general, a blockchain is a growing list of records called blocks that are linked using cryptography. Each block contains a cryptographic hash of a previous block in the blockchain, a timestamp and transaction data (referred to herein as a blockchain value). By design, a blockchain is resistant to modification of the data that records transactions between two parties efficiently and in a verifiable and permanent way. When used in distributed ledger application, a blockchain is managed by a peer-to-peer (P2P) network of nodes that collectively adhere to a protocol for inter-node communication and validating new blocks. Once recorded, the transaction data in any given block cannot be altered retroactively without alteration of all subsequent blocks in the blockchain, which in distributed ledger application requires a consensus of a majority of P2P network nodes.

For the secure safety-critical system log application described herein, it is proposed to combine the cryptographic aspects of blockchain technology (without use of a P2P network for new entry validation) with the CRC chained entry methodology described above with respect to FIG. 6E, to eliminate the possibility of log rewrites following insertion or deletion of an entry in sequence of entries of a log. In a log application, a P2P network node validation would not be practical in systems constrained by computational power or logging frequency, such as a system event log for an AV.

The blockchain of entries methodology illustrated in FIG. 6F operates much in the same manner as the chained CRC entries methodology illustrated in FIG. 6E. The addition of the encrypted blockchain value, however, provides a more secure mechanism which cannot be replicated without possession of information stored in a cryptographic unit (“crpyto unit”). In the example shown, BO is a blockchain root value located at the beginning of log 600 and the blockchain entries (BE1 . . . BEn) include respective data entries (E1 . . . En) and encrypted blockchain values (B1 . . . Bn). The blockchain root value BO is linked to blockchain value B1 in BE1, which is linked to B2 in BE2, and so forth. In an embodiment, each block chain value is a hash generated by a cryptographic operation (e.g., a message digest). The block chain entry also includes a timestamp and, optionally, a digital signature to authenticate the data source for the entry.

The blockchain of entries methodology protects against both unintentional and intentional damage but has a high additional computational cost due to the complexity of the cryptographic operations. Because of this high additional computational cost, it is not possible to guarantee that each entry can be added to the log in a timely manner for systems that are constrained by logging frequency, such as the case with AV log systems.

### Secure Safety-Critical System Log

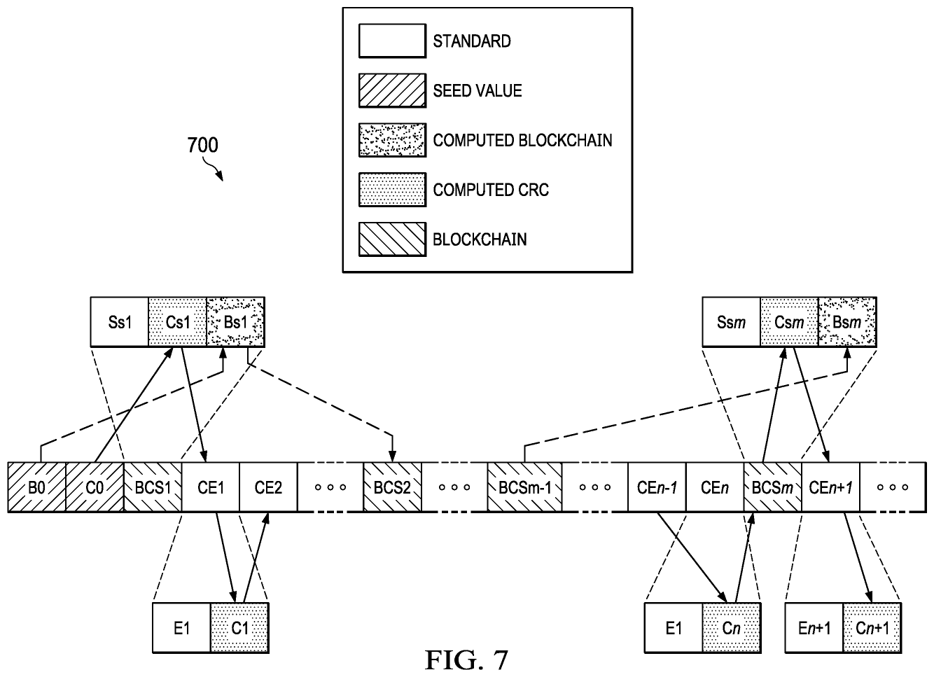

FIG. 7 is a flow diagram of a process of a secure safety-critical system log methodology that combines the CRC chained entries methodology with the blockchain of entries methodology described in reference to FIGS. 6E and 6F, respectively. An example log 700 is shown with entries that are filled with line patterns according to the legend also shown in FIG. 7.

Referring to the beginning of log 700 (far left side of the sequence of entries), log 700 begins with a blockchain root block (BO), followed by a CRC root (CO), as previously described in reference to FIGS. 6E and 6F. In another embodiment, B0 can come before CO in the sequence of entries comprising the log 700. Log 700 also includes chained CRC entries (CE1 . . . CEn) and chained sentinels (BCS1 . . . BCS1m) that are interleaved between the chained CRC entries in log 700. Hereinafter, chained CRC entries (CE1 . . . CEn) will also be referred to as “data entries” to distinguish them from chained sentinel entries (BCS1 . . . BCS1m). Note that the subscripts n and m are positive integers that represent the number data log entries and the number of sentinel entries in log 700, respectively, where m<n. The frequency of sentinels in log 700 is determined by timing constraints of the system being logged and a practical window of interest within the log. A practical window of interest may be based on data rates available for detecting system events (e.g., sensor data rates) and/or an incident time window. For example, the frequency of logging should ensure that important events that may be used in reconstructing an incident are captured in the log entries. In an embodiment, each sentinel includes identification data (e.g., arbitrary data) indicating that the entry is a sentinel (Ss1 . . . Ssm), a CRC entry (Cs1 . . . Csm) and an encrypted blockchain value (Bs1 . . . Bsm). Each sentinel includes a CRC and are block chained together, where each sentinel blockchain value (Bs1 . . . Bsm) is linked to a previous blockchain value stored in a preceding sentinel. The CRC entries (Cs1 . . . Csm) are linked through both the sentinel and the data log entries (i.e., entries that are not sentinels). In this manner, the sentinels are anchored within the sequence of entries in log 700.

Note that the difference between the Cs# and C# elements is notational only. Both are CRCs and are computed in the same manner. Operationally, the logging system would hold the last set of blockchain and CRC values in memory. These would then be used in the creation of the next entry written to the log, whether sentinel or data. These values are seeded from the B0 and C0, with B0 typically being linked to the root-of-trust of the device and C0 being randomly generated.

At the creation of the log, the B0 and C0 blocks are written to the log and an initial sentinel entry (BCS1) is created and written. Subsequent entries will use the in-memory value of the CRC in creation of the new entry's CRC. This is the case for both sentinel and data entries. Whenever sentinel entries are written, the in-memory blockchain value will also be used.

It is typically the case that when a log file is created that an entry is written by the logging system itself (log file created). This is not required, however. As such, it would be possible for the initial sentinel to be followed by another sentinel without intervening data entries. This is also the case for arbitrary points within the log. This might indicate a sentinel cadence of higher resolution than the incoming log data.

The sentinels need only be written at the granularity of shortest duration. That is to say that if you only analyze data in blocks of X seconds, you would gain nothing by having sentinels every X/2 seconds.

Referring again to the beginning of log 700, following B0 and CO, is a first sentinel entry (BCS1). BCS1 includes Ss1, Cs1 and Bs1. Cs1 is linked to C0 and Bs1 is linked to B0. Following BCS1 is chained entry CE1, which includes data log entry E1 and C1. C1 is linked to C2 in chained entry CE2, C2 is linked to C3 in CE3 and so forth, until the next sentinel BCS2 in the sequence of entries. Bs1 in BCS1 is linked to both B0 and Bs2 in BCS2 and so forth.

The combined CRC chained entry and blockchain of entries methodology described above provides the advantages of protecting against both unintentional and intentional damage to entries and has a lower computational cost than the blockchain of entries methodology. These advantages make the embodiment of FIG. 7 suitable for safety-critical systems that are constrained by computational power and logging frequency, such as event log systems for AVs.

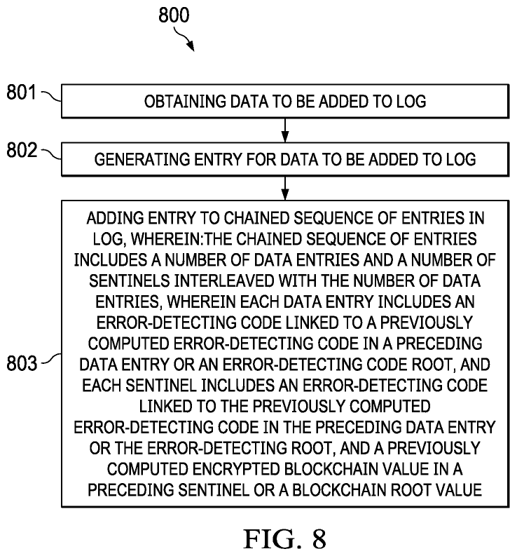

FIG. 8 is a flow diagram of a process 800 of generating a secure safety-critical system log, in accordance with one or more embodiments. Process 800 can be implemented using, for example, computer system 300 described in reference to FIG. 3.

Process 800 begins by obtaining, using at least one processor, log data to be stored in a log file (801). For example, an ingestion engine of a log management system (see FIG. 5) can be configured to receive or collect event log data that is sent by the various data sources. For example, for AV log systems, the data streams can be provided by sensors (e.g., cameras, LiDAR, RADAR, SONAR) and the AV software stack, such as from modules 402, 404, 406, 408 described in reference to FIG. 3. The data streams can be obtained from, for example, a controller area network (CAN) bus, CAN flexible data rate (CAN-FD) bus and/or from a vehicle Ethernet.

Process 800 continues by creating, using the at least one processor, a data log entry for the log data (802). For example, a log entry can be a data structure that includes log data, a timestamp and an error-correction code, such as a CRC codeword.

Process 800 continues by adding, using the at least one processor, the data log entry to a blockchain of log entries in the log file (803). In an embodiment, the sequence of chained entries includes a number of data entries and a number of sentinels interleaved with the number of data entries, wherein each data entry in the chain of entries is appended to an error-detecting code computed for the entry and a previously computed error-detecting code of a preceding data entry or an error-detecting root, and each sentinel in the chain of entries includes an error-detecting code computed for the sentinel and a previously computed error-detecting code of a preceding data entry or the error-detecting root, and each sentinel includes a previously computed and encrypted blockchain value of a preceding sentinel or a blockchain root value.

In the foregoing description, embodiments of the invention have been described with reference to numerous specific details that may vary from implementation to implementation. The description and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further including,” in the foregoing description or following claims, what follows this phrase can be an additional step or entity, or a sub-step/sub-entity of a previously-recited step or entity.

What is claimed is:

1. A method comprising:
obtaining, using at least one processor of a log system, data to be added to a log;
creating, using the at least one processor, an entry for the data; and
adding, using the at least one processor, the entry to a sequence of chained entries in the log, wherein:
the sequence of chained entries includes a number of data entries and a number of sentinels interleaved with the number of data entries, wherein each data entry in the chain of entries is appended to an error-detecting code computed for the entry and a previously computed error-detecting code of a preceding data entry or an error-detecting root, and each sentinel in the chain of entries includes an error-detecting code computed for the sentinel and a previously computed error-detecting code of a preceding data entry or the error-detecting root, and each sentinel includes a previously computed and encrypted blockchain value of a preceding sentinel or a blockchain root value.

2. The method of claim 1, wherein the error-detecting code is cyclic-redundancy check (CRC) code.

3. The method of claim 1, wherein a first entry in the chain of entries includes the blockchain root value and a second entry, following the first entry, in the chain of entries includes the error-detecting root.

4. The method of claim 1, wherein a first log entry in the chain of entries includes the error-detecting root and a second entry, following the first entry, in the chain of entries includes the blockchain root value.

5. The method of claim 1, wherein each sentinel further includes identification data indicating that the sentinel is a sentinel.

6. The method of claim 1, wherein the sentinels are interleaved with the data entries at a specified frequency determined by a timing constraint.

7. The method of claim 1, wherein the sentinels are interleaved with the data entries at a specified frequency determined by a window of interest within the log.

8. The method of claim 1, wherein each encrypted blockchain value is a hash generated by a cryptographic operation.

9. The method of claim 1, wherein each data entry and each sentinel includes a timestamp.

10. The method of claim 1, wherein the data entry includes data associated with an autonomous vehicle.

11. A log management system comprising:
at least one processor; and
memory storing instructions that when executed by the at least one processor, causes the at least one processor to add an entry to a log comprising a chained sequence of entries, where each chained entry in the chained sequence of entries is either a data entry or a sentinel, where each sentinel includes an encrypted blockchain value based on a previously computed blockchain value stored in a preceding sentinel and a previously computed error-detecting code stored in a preceding data entry, and wherein the error-detecting code tracks through the sentinels and the data entries in the chain of entries.

12. The system of claim 11, wherein the error-detecting code is cyclic-redundancy check (CRC) code.

13. The system of claim 11, wherein the first two values in the log are the blockchain root value (B0) and error-detecting root value (C0) or vice-versa.

14. The system of claim 11, wherein at creation of the log, B0 and C0 are written to the log and an initial sentinel entry (BCS1) is created and written to the log, subsequent entries in the log use an in-memory value of the CRC in creation of a CRC for new log entries for sentinel and data entries, and whenever sentinel entries are written, an in-memory blockchain value is used.

15. The system of claim 11, wherein a first entry in the chained sequence of entries is a sentinel entry and includes the error-detecting root value and the blockchain root value.

16. The system of claim 11, wherein each sentinel further includes identification data indicating that the sentinel is a sentinel.

17. The system of claim 11, wherein the sentinels are interleaved with the data entries at a specified frequency determined by a timing constraint.

18. The system of claim 11, wherein the sentinels are interleaved with the data entries at a specified frequency determined by a window of interest within the log.

19. The system of claim 11, wherein each encrypted blockchain value is a hash generated by a cryptographic operation.

20. The system of claim 11, wherein each data entry and each sentinel includes a timestamp.

21. The system of claim 11, wherein the data entry includes data associated with an autonomous vehicle.
